(19) United States
(12) Patent Application Publication
(10) Pub. No.: US 2007/0296645 A1
(43) Pub. Date: Dec. 27, 2007

(54) Display apparatus using laser and method of using the same

(75) Inventors: Kye-hoon Lee, Suwon-si (KR); Kun-ho Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/802,152

(22) Filed: May 21, 2007

(30) Foreign Application Priority Data
Jun. 20, 2006 (KR) 2006-55402

(51) Int. Cl. G09G 5/00

(52) U.S. Cl. 345/6; 359/201

(57) ABSTRACT

A display apparatus which uses a laser to realize a clear image by reducing speckle noise is provided. The display apparatus comprises a laser light source which emits light a scanning mirror which scans light emitted by the laser light source, a speckle removing mirror which periodically reciprocates within a predetermined rotating angle, and projects the light scanned by the scanning mirror, to a screen, and an image processor which processes image data to shift an image by frame corresponding to the rotation of the speckle removing mirror.

### CROSS-REFERENCE TO RELATED APPLICATIONS

This application claims the benefit under 35 U.S.C. §119(a) of Korean Patent Application No. 2006-0055402, filed on Jun. 20, 2006, in the Korean Intellectual Property Office, the entire disclosure of which is hereby incorporated herein by reference.

### BACKGROUND OF THE INVENTION

1. Field of the Invention

The present invention relates to a display apparatus which uses a laser. More particularly, the present invention relates to a display apparatus which uses a laser to realize a clear image by reducing speckle noise.

2. Description of the Related Art

Growing demands for display apparatuses and high quality have caused projectors capable of enlarging and projecting small images through projection lenses to rapidly expand. Projectors can be divided into front image projection devices and rear image projection devices according to the projection type. Also, new projectors have been developed to project an image to a screen through a laser light source by using highly collimated light from lasers.

When a laser is used as a light source, a speckle occurs by high interference of laser light. When the laser light is reflected from a screen, destructive and constructive interferences occur in front of the screen, to generate a speckle. The speckle noise adversely affects a realization of a clear image on the screen and lowers image quality.

Accordingly, there is a need for an improved system and method for providing a display apparatus which uses a laser to realize a clear image by reducing speckle noise.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a display apparatus and method which uses a laser to realize a clear image by reducing speckle noise.

To accomplish this object, in accordance with one aspect of an exemplary embodiment of the present invention, a method of using a laser to realize a clear image is provided. Light is emitted and then scanned by a scanning mirror. A speckle removing mirror is periodically reciprocated within a predetermined rotating angle and light scanned by the scanning mirror is projected to a screen. Image data is then processed to shift an image by a frame corresponding to the rotation of the speckle removing mirror.

According to another exemplary embodiment of the present invention, a display apparatus which uses a laser is provided. The display apparatus comprises a laser light source, a scanning mirror, a speckle removing mirror and an image processor. The laser light source emits light and the scanning mirror scans light emitted by the laser light source. The speckle removing mirror periodically reciprocates within a predetermined rotating angle, and projects the light scanned by the scanning mirror, to a screen. The image processor processes image data to shift an image by frame corresponding to the rotation of the speckle removing mirror.

According to an exemplary embodiment of the present invention, display regions of the screen displaying the image of adjacent frames are spaced from each other at a predetermined interval by the rotation of the speckle removing mirror, and the image processor shifts the image by as much as the interval between the display regions.

According to another exemplary embodiment of the present invention, a single frame comprises a plurality of pixels formed as a matrix, and the image processor shifts the image by as much as the interval between the display regions spaced upward and downward, in a column direction of the frame when the speckle removing mirror rotates in upward and downward directions of the screen.

According to still another exemplary embodiment of the present invention, a single frame comprises a plurality of pixels formed as a matrix, and the image processor shifts the image by as much as the interval between the display regions spaced leftward and rightward, in a row direction of the frame when the speckle removing mirror rotates in leftward and rightward directions of the screen.

According to a further exemplary embodiment of the present invention, the image processor processes the image data to alternately display the image on a first display region and a second display region spaced from the first display region.

According to an exemplary embodiment of the present invention, the speckle removing mirror moves to at least one sub rotating angle point within the rotating angle, and the image processor processes the image data corresponding to the time when the speckle removing mirror moves to the respective sub rotating angle points.

In an exemplary implementation of the present invention, the 2n+2 number of frames are formed during one rotation of the speckle removing mirror when the n number of sub rotating angle points are provided within the rotating angle.

In another exemplary implementation of the present invention, the speckle removing mirror moves to at least one sub rotating angle point within the rotating angle, and the image processor processes the image data corresponding to the time when the speckle removing mirror moves to the respective sub rotating angle points.

In still another exemplary implementation of the present invention, the 2n+2 number of frames are formed during one rotation of the speckle removing mirror when the n number of sub rotating angle points are provided within the rotating angle.

According to an exemplary embodiment of the present invention, the scanning mirror comprises a first scanning mirror to scan light in leftward and rightward directions of the screen, and a second scanning mirror to scan light in upward and downward directions of the screen.

According to an exemplary embodiment of the present invention, the display apparatus further comprises a laser modulator which adjusts the amount of light of the laser light source based on the image data processed by the image processor.

According to an exemplary embodiment of the present invention, the laser light source comprises red, green and blue lasers.

According to yet another exemplary embodiment of the present invention, the display apparatus further comprises a light synthesizer which synthesizes light emitted by the respective lasers.

According to an exemplary embodiment of the present invention, the display apparatus further comprises a collimator lens which is provided between the light synthesizer and the scanning mirror and collects light emitted by the light synthesizer.

The foregoing and/or other aspects of exemplary embodiments of the present invention are also achieved by providing a display apparatus which uses a laser. The display apparatus comprises a screen a laser light source, a scanning mirror, a speckle removing mirror and an image processor. The laser light source emits light and the scanning mirror scans light emitted by the laser light source, to the screen. The speckle removing mirror is provided between the screen and the scanning mirror, and periodically reciprocates within a predetermined rotating angle. The image processor alternately processes an image corresponding to a first frame and an image corresponding to a second frame shifted corresponding to the rotation of the speckle removing mirror, and a time interval of the first and second frames being ½ of a rotation period of the speckle removing mirror.

According to an exemplary embodiment of the present invention, the speckle removing mirror moves to at least one sub rotating angle point within the rotating angle, and the image processor forms at least one third frame or more frames corresponding to the time when the speckle removing mirror moves to the respective sub rotating angle points.

According to an exemplary embodiment of the present invention, a single frame comprises a plurality of pixels formed as a matrix, and the image processor shifts the image as much as the interval between the display regions spaced upwards and downwards, in a column direction of the frame when the speckle removing mirror rotates in upward and downward directions of the screen.

According to an exemplary embodiment of the present invention, a single frame comprises a plurality of pixels formed as a matrix, and the image processor shifts the image by as much as the interval between the display regions spaced leftward and rightward, in a row direction of the frame when the speckle removing mirror rotates in leftward and rightward directions of the screen.

According to an exemplary embodiment of the present invention, the laser light source comprises red, green and blue lasers, further comprising a light synthesizer which synthesizes light emitted by the respective laser.

Other objects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and/or other exemplary objects, features and advantages of certain exemplary embodiments of the present invention will be more apparent from the following description taken in conjunction with the accompanying drawings, in which:

FIG. 1 is a schematic view of a display apparatus according to a first exemplary embodiment of the present invention;

FIG. 2 is a control block diagram of the display apparatus according to the first exemplary embodiment of the present invention;

FIGS. 3a to 3d illustrate a speckle removing mirror and a display region according to the first exemplary embodiment of the present invention;

FIGS. 4a to 4b illustrate a speckle removing mirror and display region according to a second exemplary embodiment of the present invention; and

FIG. 5 illustrates a display region according to a third exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

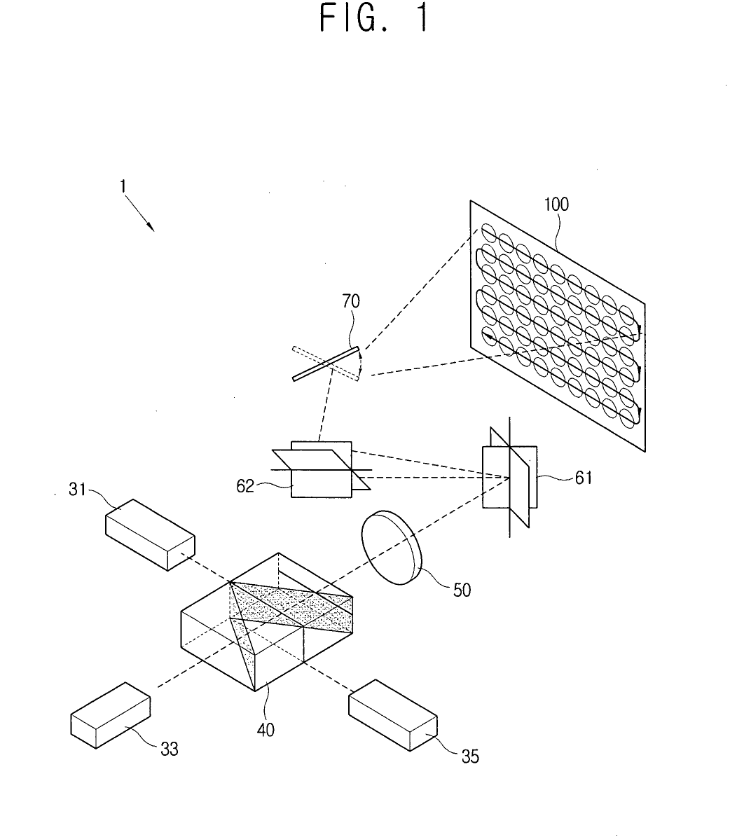

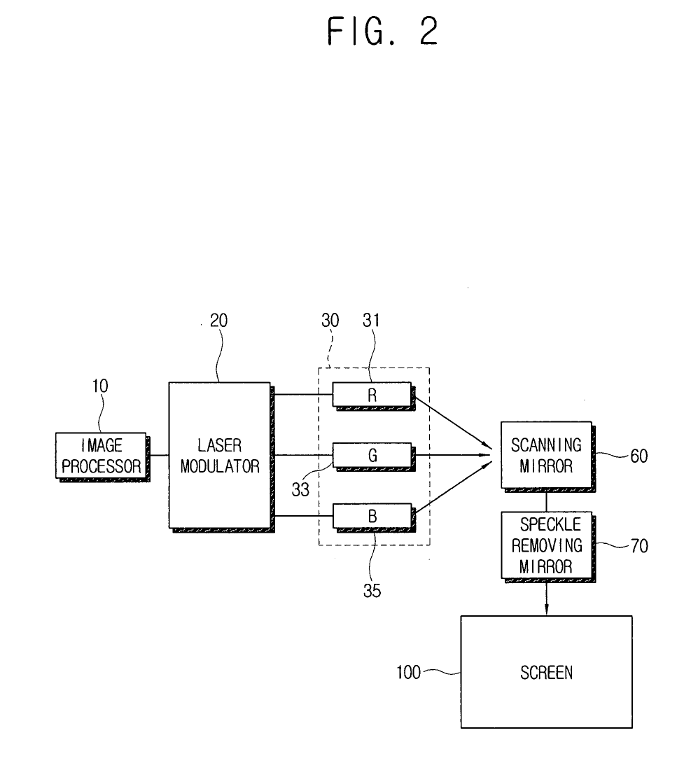

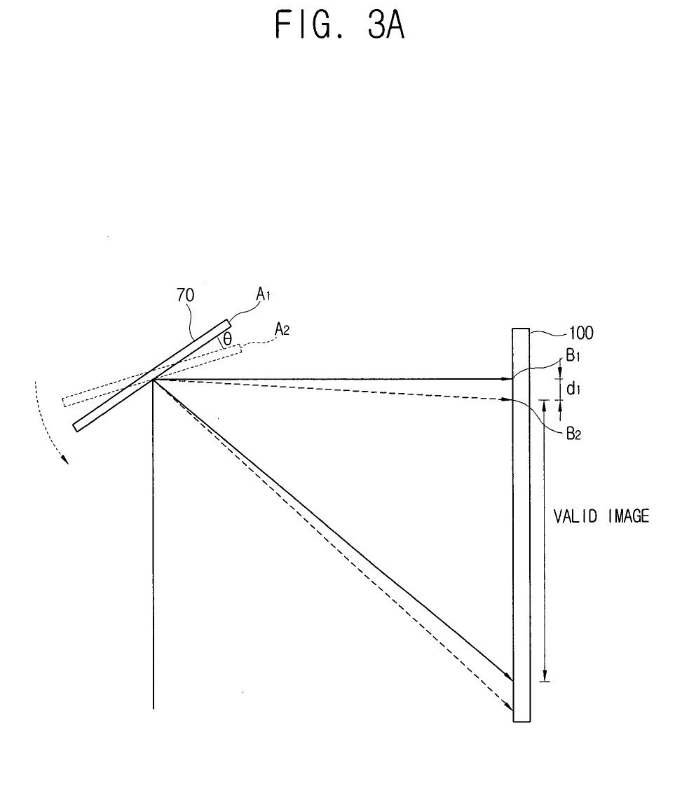

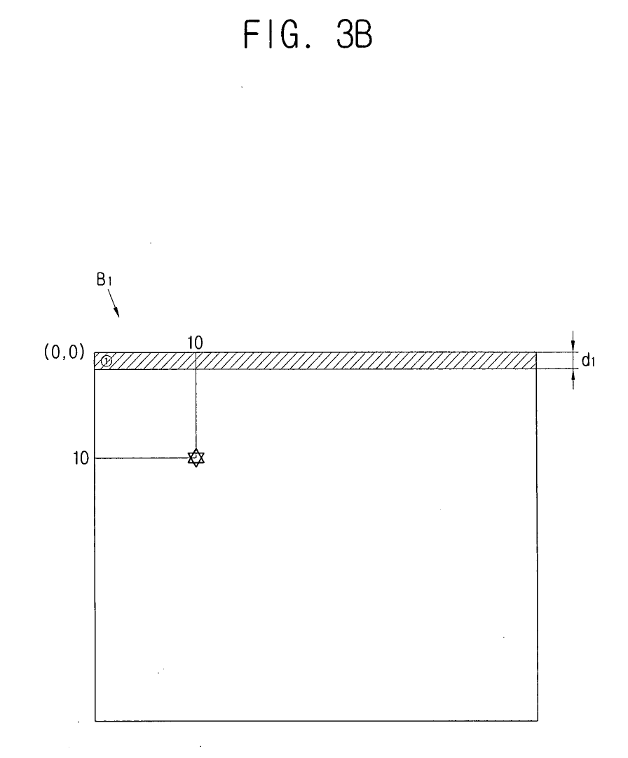

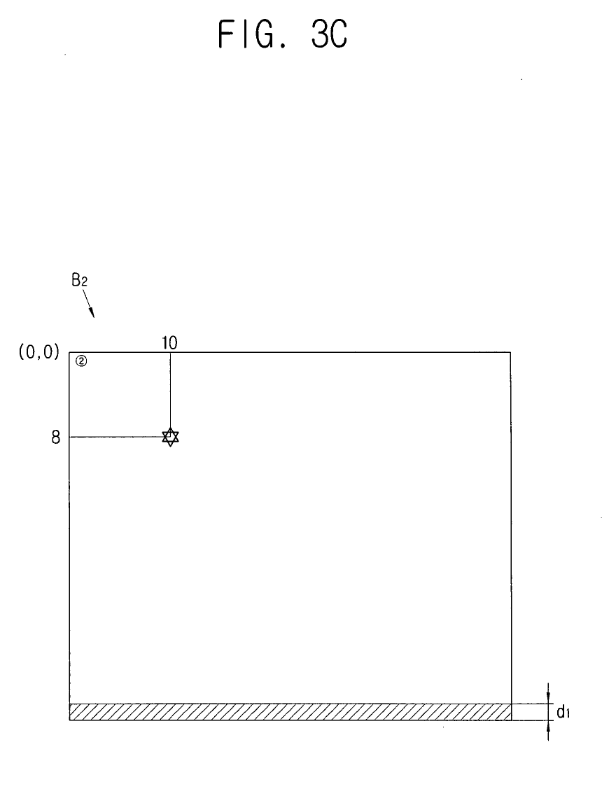

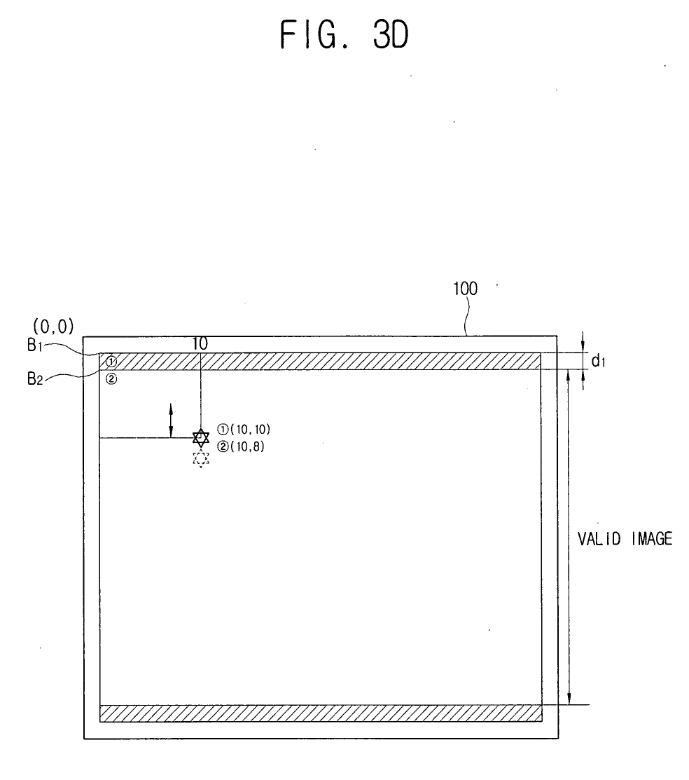

FIG. 1 is a schematic view of a display apparatus according to a first exemplary embodiment of the present invention. FIG. 2 is a control block diagram of the display apparatus according to the first exemplary embodiment of the present invention. FIGS. 3a to 3d illustrate a speckle removing mirror and a display region according to the first exemplary embodiment of the present invention.

A display apparatus 1, according to a first exemplary embodiment of the present invention as illustrated in FIGS. 1 and 2, comprises an image processor 10, a laser light source 30, a laser modulator 20, at least one scanning mirror 60 and a speckle removing mirror 70. The image processor 10 processes an external image signal. The laser modulator 20 adjusts the amount of light of the laser light source 30 and at least one scanning mirror 60 scans light from the laser light source 30 to a screen 100. The speckle removing mirror 70 is provided between the scanning mirror 60 and the screen 100 to vibrate the light. The display apparatus 1 further comprises a light synthesizer 40 which synthesizes the light from the laser light source 30 and a collimator lens 50 which collects the synthesized light.

The display apparatus 1, according to an exemplary embodiment of the present invention, comprises various display apparatuses which realize an image on the screen 100 by using the laser light source 30 and the scanning mirror 60. Particularly, the display apparatus 1, according to an exemplary embodiment of the present invention, comprises a rear projector and a front projector. The rear projector has an image optical system with a lens and a light source behind the screen 100 to project light and the front projector has the image optical system in front of the screen 100 to emit light in front thereof. An exemplary embodiment of the present invention can be applicable to a television or a monitor which comprises a laser.

The image processor 10 processes image data input from the outside to be supplied to the laser modulator 20. The image processor 10 processes the image data supplied from a broadcasting company, a computer main body or an external video card. The image processor 10 processes the image data that is to be used by the laser light source 30. The image processor 10 also processes the image data so that the laser light source 30 realizes a color of the image to be displayed in each pixel. The image processor 10 processes the image data of a frame to be displayed on a certain part of the screen 100, namely, adjusting a display region of the image on the screen 100.

The laser light source 30 emits light in three colors to realize the image. The laser light source 30 comprises a red laser 31, a green laser 33 and a blue laser 35. The respective lasers 31, 33 and 35 have image information on a single pixel. A single beam with a combination of red, green and blue colors is projected to each pixel to form a single frame, and the image is realized by the consecutive frames of the above single frames. The light emitted by the laser light source 30 is not limited to red, green and blue colors. Alternatively, the light emitted by the laser light source 30 may comprise cyan, magenta and yellow colors by adjusting a wavelength of the laser.

The laser modulator 20 adjusts the amount of light of the respective lasers 31, 33 and 35 based on the image data processed by the image processor 10. As the single beam projected to the single pixel realizes a certain color through the combination of the three colors, the ratio between red, green and blue colors varies in each pixel. Thus, the laser modulator 20 adjusts the amount of light of the respective lasers 31, 33 and 35 in each pixel, corresponding to different color ratios.

The light synthesizer 40 synthesizes the light from the respective lasers 31, 33 and 35. The light emitted from the lasers 31, 33 and 35 is mixed by the light synthesizer 40 and projected to the scanning mirror 60, instead of being individually scanned to the screen 100. The light synthesizer 40 may comprise a light guiding pipe. A plurality of reflecting plates or mirrors is provided within the light guiding pipe. The reflecting plates or mirrors guide the light supplied from different directions, toward the scanning mirror 60. The light synthesizer 40 may further comprise a reflecting mirror which is provided in a wall to reduce light loss due to light absorption of the wall.

The collimator lens 50 is provided between the light synthesizer 40 and the scanning mirror 60 to collect light from the light synthesizer 40 and to compensate the light as a parallel light. More than one collimator lens 50 may be provided and may be provided between the elements from which light is emitted.

The scanning mirror 60 comprises a first scanning mirror 61 and a second scanning mirror 62 to scan the light from the laser light source 30 in leftward and rightward directions. The first and second scanning mirrors 61 and 62 also scan the light in upward and downward directions of the screen 100. The first scanning mirror 61 rotates in leftward and rightward directions of the screen 100 along a predetermined axis and scans the light to leftward and rightward directions of the screen 100. The second scanning mirror 62 rotates in upward and downward directions of the screen 100 along a predetermined axis, and scans the light in upward and downward directions of the screen 100. The light from the laser light source 30 comprises image information on each pixel, and forms consecutive frames by being consecutively scanned. The rotating speed of the scanning mirror 60 may be variously adjusted corresponding to a frequency of displaying images. The image may be scanned in a zigzag pattern since the rotating speed of the scanning mirror 60 is very fast and the first and second scanning mirrors 61 and 62 can rotate simultaneously. The image scanning direction is not limited to a certain direction, and may vary according to the number of the scanning mirrors 60 and the rotating direction thereof.

The speckle removing mirror 70 is provided between the scanning mirror 60 and the screen 100 and periodically reciprocates within a predetermined rotating angle θ. High interference of laser light produces a speckle when a laser is used as a light source. When the laser light is reflected from the screen 100, destructive and constructive interferences occur in front of the screen 100, thereby generating a speckle. When the speckle removing mirror 70 vibrates fast, the laser light also vibrates fast, thereby vibrating the speckle corresponding to the laser light. Then, the speckle is less visible to a user. The speckle removing mirror 70 dilutes the speckle by vibrating the laser light. When the speckle is removed, the quality of an image displayed on the screen 100 improves.

However, when the speckle removing mirror 70 is used, the image displayed on the screen 100 is shaken according to the vibration of the speckle removing mirror 70. Thus, the image is shifted corresponding to a vibration period of the speckle removing mirror 70. According to an exemplary implementation, a method of compensating the image shifted by the vibration of the speckle removing mirror 70 will be described with reference to FIGS. 3a to 3d. FIG. 3a is a cross-sectional view of the speckle removing mirror 70 and the screen 100. FIG. 3b illustrates the image displayed on the screen 100 according to the first exemplary embodiment of the present invention. FIG. 3c illustrates a first frame which is formed by the image processor 10. FIG. 3d illustrates a second frame which is formed by the image processor 10.

According to an exemplary implementation, a display region refers to a region where the image of a single frame is displayed on the screen 100. The frame comprises a plurality of pixels making a matrix. The image processor 10 processes the image data to adjust the amount of blue, green and red light corresponding to the respective pixels. The image processor 10, according to an exemplary embodiment of the present invention, processes the image data to display the image of the single frame on the screen 100 when the speckle removing mirror 70 stops at a predetermined position. Even though the laser light is scanned in each pixel, the display apparatus 1, according to the first exemplary embodiment of the present invention, controls the image by frame and scans the image by frame when the speckle removing mirror 70 stops at the predetermined position, thereby compensating the image shifted corresponding to the rotation of the speckle removing mirror 70.

When compensation is not made for the image, even though the speckle removing mirror 70 rotates, the image remains shaken on the screen 100 and the image quality is lowered. That is, when the speckle removing mirror 70 is positioned at a first point A1, the image is displayed in a first display region B1. When the speckle removing mirror 70 moves to a second point A2, the image also moves down by a predetermined distance d1 to be positioned in a second display region B2. With the repetition of the above process, the image is shaken.

The image processor 10, according to the first exemplary embodiment of the present invention, processes the image data to shift the image by a frame to solve the above problem. As illustrated in FIG. 3b, a first frame \textcircled{1} of the image to be displayed on the first display region B1 forms a white, gray or black default pixel in an upper part of the region. As illustrated in FIG. 3c, a second frame \textcircled{2} of the image to be displayed on the second display region B2 forms a white, gray or black default pixel in a lower part thereof. Imagine that a shape is displayed in a pixel (10, 10), such as, in a tenth column and tenth row of the first frame \textcircled{1}. When a distance d₁ of the image shifted by the speckle removing mirror 70 corresponds to two rows in a single frame, the image processor 10 processes the image to be displayed on a pixel (10,8) of the second frame \textcircled{2} adjacent to the first frame \textcircled{1}. The overall image corresponding to the single frame is adjusted upwards in a column direction, thereby displaying the shape in the same region of the screen 100. As illustrated in FIG. 3d, the display regions B1 and B2 display the first and second frames \textcircled{1} and \textcircled{2} and are spaced apart by the distance d₁ from each other by the speckle removing mirror 70. However, the image processor 10 forms the same image on different pixels (10, 10) and (10, 8) by respective frames \textcircled{1} and \textcircled{2}, thereby providing an effect as if the fixed image is displayed on the screen 100. A valid image on the screen 100 is displayed except for lower and upper default regions of respective frames \textcircled{1} and \textcircled{2}, which are formed from the default pixels for the compensation for the image. Unless the image processor 10 revises the image, a user recognizes the dotted-lined star as illustrated in FIG. 3d, and acknowledges that the image is shaken by the frame.

The image processor 10 processes the image data so that the image corresponding to the first frame \textcircled{1} is displayed on the screen 100 when the speckle removing mirror 70 is positioned at the first point A₁, and the image corresponding to the second frame \textcircled{2} is displayed on the screen 100 when the speckle removing mirror 70 is positioned at the second point A₂. The image processor 10 processes the image data to alternately display the first and second frames \textcircled{1} and \textcircled{2} on the first and second display regions B1 and B2. A time interval between the first and second frames \textcircled{1} and \textcircled{2} accounts for ½ of the rotation period of the speckle removing mirror 70.

The default pixel displayed in the upper or lower part of the first and second frames \textcircled{1} and \textcircled{2} is not compulsory. As a pixel region used for the default pixel is very small compared to the size of a single frame, several rows may be used as the default pixel. When the resolution of the image is low, the default pixel may be not formed.

The display apparatus 1, according to the first exemplary embodiment of the present invention, does not comprise the screen 100. Alternatively, the display apparatus 1, according to another exemplary embodiment of the present invention, may comprise the screen 100. The screen 100 may be selectively provided to realize the display apparatus 1 according to an exemplary embodiment of the present invention.

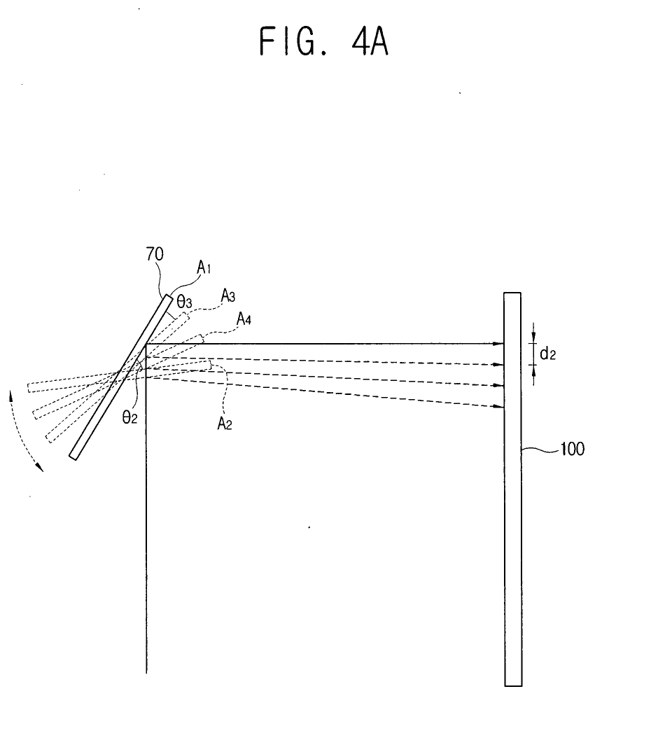

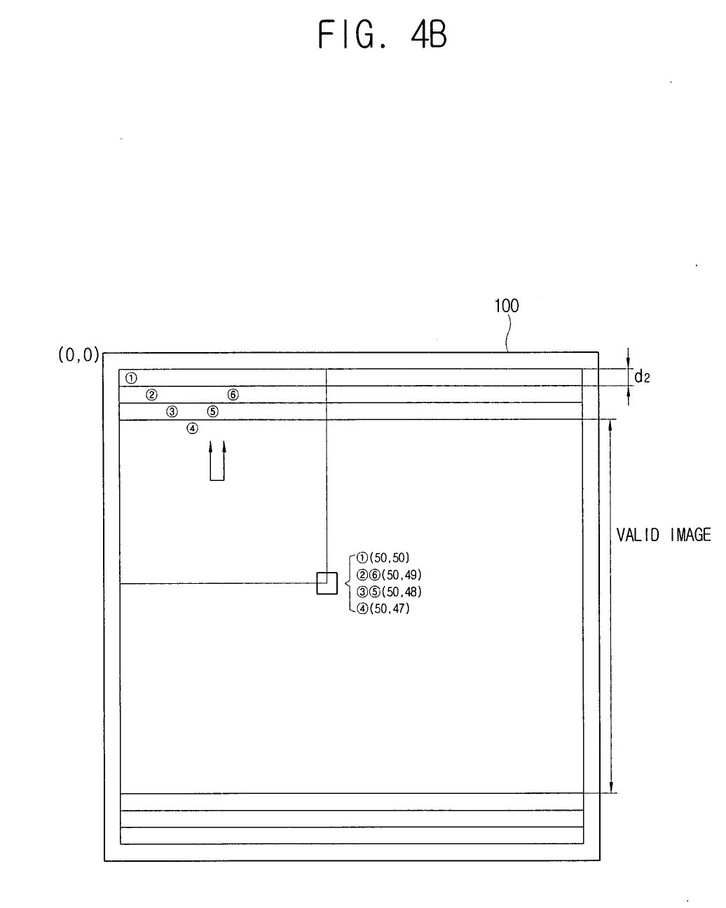

FIGS. 4a and 4b illustrate a speckle removing mirror and a display region according to a second exemplary embodiment of the present invention.

As shown therein, a speckle removing mirror 70 moves to two sub rotating angle points A₃ and A₄ formed within a rotating angle θ2 of a first point A₁ and a second point A₂. Whenever the speckle removing mirror 70 moves to the respective points A₁, A₂, A₃ and A_{4,} an image processor 10 processes image data. That is, at least three frames are formed while the speckle removing mirror 70 rotates once.

When the speckle removing mirror 70 moves to the sub rotating angle points A₃ and A₄ within the rotating angle θ2, an angle θ3 between the respective points A₁, A₂, A₃ and A₄ corresponds to ⅓ of the rotating angle θ2. Whenever the speckle removing mirror 70 moves with the predetermined angle θ3 from the first point A₁, the frame with a shifted image is formed.

As illustrated in FIG. 4b, a total of six frames are formed while the speckle removing mirror 70 rotates once. The first to fourth frames \textcircled{1}, \textcircled{2}, \textcircled{3} and \textcircled{4} move downwards on the screen 100 with a predetermined interval d₂, and the fifth and sixth frames \textcircled{5} and \textcircled{6} move upwards on the screen 100. However, the image processor 10 shifts the image of each frame in a column direction to compensate for the image shifted according to the movement of the display region. A rectangle formed in a pixel (50, 50) of the first frame \textcircled{1} moves via pixels (50, 49), and (50, 48) of the second and third frames \textcircled{2} and \textcircled{3}, to pixel (50, 47) of the fourth frame \textcircled{4}, and moves to pixels (50, 48), and (50, 49) of the fifth and sixth frames \textcircled{5} and \textcircled{6} in which the display region moves upwards.

When the “n” number of sub rotating angle points in a single rotating angle are provided, the “2n+2” number of frames are formed while the speckle removing mirror 70 rotates once. The “n” number of frames, except the first and fourth frames \textcircled{1} and \textcircled{4}, are displayed on the same display region twice according to an exemplary embodiment of the present invention.

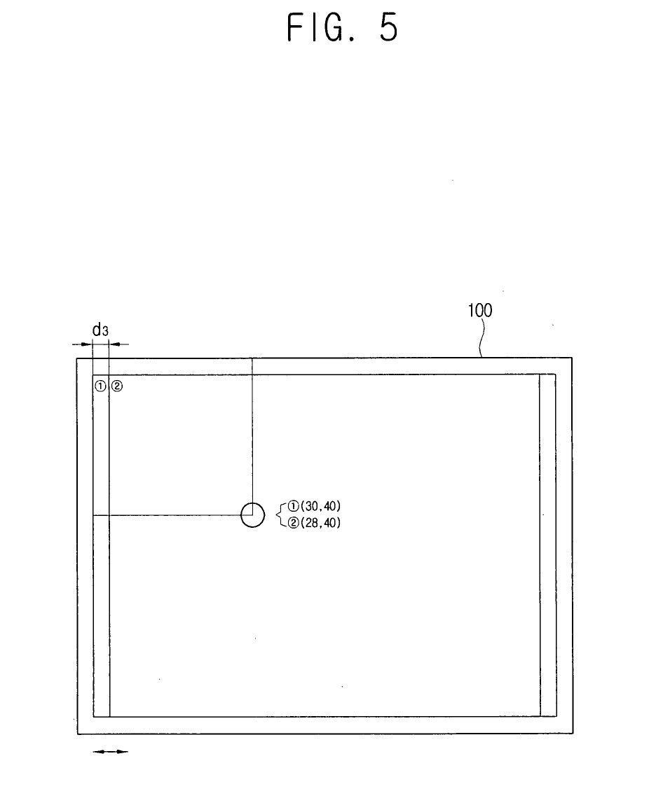

FIG. 5 illustrates a display region according to a third exemplary embodiment of the present invention.

A speckle removing mirror 70, according to the third exemplary embodiment of the present invention, reciprocates within a predetermined rotating angle in leftward and rightward directions of a screen 100. According to an exemplary implementation, an image is shaken leftward and rightward on the screen 100. Thus, an image processor 10 shifts an image of a second frame \textcircled{2} adjacent to a first frame \textcircled{1} in a row direction by an interval d₃. When a circle is displayed on a pixel (30, 40) of the first frame \textcircled{1} and when the interval d₃ of the image shifted by the speckle removing mirror 70 corresponds to two columns in a single frame, the image processor 10 displays the circle on a pixel (28, 40) of the second frame \textcircled{2} adjacent to the first frame \textcircled{1}.

The image shifting direction is not limited to upward and downward directions, or leftward and rightward directions. Alternatively, the image may be shifted in a diagonal direction of the screen 100 according to the rotating direction of the speckle removing mirror 70. The default pixel may be set by a user according to the size and resolution of the screen 100.

As described above, an exemplary embodiment of the present invention provides a display apparatus which uses a laser to reduce speckle noise and realize a clear image.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A display apparatus which uses a laser, comprising:
a laser light source for emitting light;
a scanning mirror for scanning light emitted by the laser light source;
a speckle removing mirror for periodically reciprocating within a rotating angle, and for projecting the light scanned by the scanning mirror, to a screen; and
an image processor for processing image data to shift an image by a frame corresponding to the rotation of the speckle removing mirror.

2. The display apparatus according to claim 1, wherein display regions of the screen displaying the image of adjacent frames are spaced from each other at an interval by the rotation of the speckle removing mirror, and
the image processor shifts the image by as much as the interval between the display regions.

3. The display apparatus according to claim 2, wherein a single frame comprises a plurality of pixels formed as a matrix, and
the image processor shifts the image by as much as the interval between the display regions spaced upward and downward, in a column direction of the frame when the speckle removing mirror rotates in upward and downward directions of the screen.

4. The display apparatus according to claim 2, wherein a single frame comprises a plurality of pixels formed as a matrix, and
the image processor shifts the image by as much as the interval between the display regions spaced leftward and rightward, in a row direction of the frame when the speckle removing mirror rotates in leftward and rightward directions of the screen.

5. The display apparatus according to claim 4, wherein the image processor processes the image data to alternately display the image on a first display region and a second display region spaced from the first display region.

6. The display apparatus according to claim 3, wherein the speckle removing mirror moves to at least one sub rotating angle point within the rotating angle, and
the image processor processes the image data corresponding to the time when the speckle removing mirror moves to the respective sub rotating angle points.

7. The display apparatus according to claim 6, wherein the 2n+2 number of frames are formed during one rotation of the speckle removing mirror when the n number of sub rotating angle points are provided within the rotating angle.

8. The display apparatus according to claim 4, wherein the speckle removing mirror moves to at least one sub rotating angle point within the rotating angle, and
the image processor processes the image data corresponding to the time when the speckle removing mirror moves to the respective sub rotating angle points.

9. The display apparatus according to claim 8, wherein the 2n+2 number of frames are formed during one rotation of the speckle removing mirror when the n number of sub rotating angle points are provided within the rotating angle.

10. The display apparatus according to claim 5, wherein the scanning mirror comprises a first scanning mirror to scan light in leftward and rightward directions of the screen, and a second scanning mirror to scan light in upward and downward directions of the screen.

11. The display apparatus according to claim 5, further comprising:
a laser modulator for adjusting the amount of light of the laser light source based on the image data processed by the image processor.

12. The display apparatus according to claim 5, wherein the laser light source comprises red, green and blue lasers.

13. The display apparatus according to claim 12, further comprising:
a light synthesizer for synthesizing the light emitted by the respective lasers.

14. The display apparatus according to claim 13, further comprising:
a collimator lens which is provided between the light synthesizer and the scanning mirror and which collects light emitted by the light synthesizer.

15. A display apparatus which uses laser, comprising:
a screen;
a laser light source for emitting light;
a scanning mirror for scanning light emitted by the laser light source, to the screen;
a speckle removing mirror which is provided between the screen and the scanning mirror, and which periodically reciprocates within a rotating angle; and
an image processor for alternately processing an image corresponding to a first frame and an image corresponding to a second frame shifted corresponding to the rotation of the speckle removing mirror, and
a time interval of the first and second frames comprising ½ of a rotation period of the speckle removing mirror.

16. The display apparatus according to claim 15, wherein the speckle removing mirror moves to at least one sub rotating angle point within the rotating angle, and the image processor forms at least one third frame corresponding to the time when the speckle removing mirror moves to the respective sub rotating angle points.

17. The display apparatus according to claim 15, wherein a single frame comprises a plurality of pixels formed as a matrix, and
the image processor shifts the image by as much as the interval between the display regions spaced upwards and downwards, in a column direction of the frame when the speckle removing mirror rotates in upward and downward directions of the screen.

18. The display apparatus according to claim 15, wherein a single frame comprises a plurality of pixels formed as a matrix, and
the image processor shifts the image by as much as the interval between the display regions spaced leftward and rightward, in a row direction of the frame when the speckle removing mirror rotates in leftward and rightward directions of the screen.

19. The display apparatus according to claim 15, wherein the laser light source comprises red, green and blue lasers, further comprising:
a light synthesizer for synthesizing light emitted by the respective laser.

20. A method of using a laser to realize a clear image, comprising:
emitting light;
scanning light emitted by a laser light source;
periodically reciprocating within a rotating angle;
projecting light scanned by a scanning mirror, to a screen; and
processing image data to shift an image by a frame corresponding to the rotation of a speckle removing mirror.

21. The method of claim 20, further comprising shifting the image by as much as an interval between display regions of the screen displaying the image of adjacent frames.

22. The method of claim 21, wherein the image is shifted by as much as the interval between the display regions spaced upward and downward, in a column direction of the frame when the speckle removing mirror rotates in upward and downward directions of the screen.

23. The method of claim 21, wherein the image is shifted by as much as the interval between the display regions spaced leftward and rightward, in a row direction of the frame when the speckle removing mirror rotates in leftward and rightward directions of the screen.
